(19) United States
(12) Patent Application Publication
(10) Pub. No.: US 2020/0267248 A1
(43) Pub. Date: Aug. 20, 2020

(54) MOBILE TERMINAL

(71) Applicant: MODA-INNOCHIPS CO., LTD., Ansan-Si, Gyeonggi-Do (KR)

(72) Inventors: Sung Chol PARK, Ansan-Si, Gyeonggi-Do (KR); Young Sul KIM, Seoul (KR); In Seob JEONG, Ansan-Si, Gyeonggi-Do (KR); Sang Hun PARK, Seoul (KR)

(21) Appl. No.: 15/781,473

(22) PCT Filed: Dec. 21, 2016
(86) PCT No.: PCT/KR2016/014976

§ 371 Date: Jun. 4, 2018

(30) Foreign Application Priority Data
Dec. 24, 2015 (KR) 10-2015-0186678
Dec. 15, 2016 (KR) 10-2016-0171809

(51) Int. Cl. H04M 1/03; H04R 17/00; B06B 1/06; H04M 1/02; H04R 1/02

(52) U.S. Cl. CPC H04M 1/03; H04R 17/00; B06B 1/06; H04R 2460/13; H04R 1/025; H04R 2499/11; H04M 1/0266

(57) ABSTRACT

Provided is a mobile terminal including a display configured to display an image, a window disposed on one side of the display and touchable by a user, a case disposed on the other side of the display from a side surface of the window, and an acoustic element disposed on at least one area of the case. The acoustic element generates sound through air-vibration due to oscillation or transmits sound in a bone conduction manner.

### TECHNICAL FIELD

The present disclosure relates to a mobile terminal, and more particularly, to a mobile terminal including an acoustic element in a bone conduction manner.

### BACKGROUND ART

A mobile terminal is a portable mobile electronic device having at least one of a voice and video call function, an information input/output function, and a data storage function. Accordingly, as the mobile terminal is diversified in function, the mobile terminal is being realized as a type of a multimedia player having complex functions such as photograph or video shooting, music or moving picture file playing, game playing, and broadcast receiving.

The mobile terminal is known to use a speaker as a unit for generating air-conducted sound vibrating the air during voice calling or music playing. However, when surrounding noise is greater than the air-conducted sound, the air-conducted sound may not be clearly heard.

To solve the above-described limitation, an acoustic element in a bone conduction manner transmitting sound by using vibration may be applied to the mobile terminal. The acoustic element may use a manner generating air-vibration or stimulating auditory nerves of a user to transmit sound. As described above, since the acoustic element transmits sound by using vibration, a structure more efficiently transmitting the vibration may be considered.

### PRIOR ART DOCUMENTS

Japanese Patent No. 3929465

Korean Patent Laid-Open Publication No. 2014-0074299

### DISCLOSURE OF THE INVENTION

### Technical Problem

The present disclosure provides a mobile terminal including an acoustic element in a bone conduction manner transmitting sound by using vibration.

The present disclosure also provides a mobile terminal efficiently transmitting vibration generated from an acoustic element in a bone conduction manner to a user.

### Technical Solution

In accordance with an exemplary embodiment, a mobile terminal includes a display configured to display an image; a window disposed on one side of the display and touchable by a user; a case disposed on the other side of the display from a side surface of the window; and an acoustic element disposed on at least one area of the case, and the acoustic element generates sound through air-vibration due to oscillation or transmits sound in a bone conduction manner.

The case may include a front case, a rear case, and a cover case, and the acoustic element may be disposed on at least one area of at least one of the front case, the rear case, and the cover case.

The mobile terminal may further include an opening or a groove defined in at least one area of the front case, and at least a portion of the acoustic element may be inserted into the opening or the groove.

The acoustic element may contact the display.

The acoustic element may include a module case and a piezoelectric vibration member disposed on one area of the module case.

The module case may have a rounded surface opposite to a surface contacting the piezoelectric vibration member.

The module case may include a predetermined inner space.

A material different from that of the module case may be filled in the inner space of the module case.

The module case may have opened one side.

The piezoelectric vibration member may be disposed in an inner space of the module case.

The mobile terminal may further include a weight member disposed on at least one of the module case and the piezoelectric vibration member.

The mobile terminal may further include a reinforcing material disposed on at least one area of the module case.

The reinforcing material may be spaced a predetermined distance from the piezoelectric vibration member to cover the piezoelectric vibration member.

The mobile terminal may further include a support member disposed between the display and the case, and the acoustic element may be supported on the support member.

The acoustic element may include a piezoelectric vibration member attached on the case.

A waterproofing layer may be applied on at least one area of the acoustic element.

### Advantageous Effects

In accordance with the exemplary embodiment, as the acoustic element in the bone conduction manner is mounted on the front case, the vibration generated from the acoustic element may be efficiently transmitted to the entire surface of the terminal body. That is, as the acoustic element in the bone conduction manner is provided to the front case of the mobile terminal including the front case and the rear case, the transmission path of the vibration may decrease to reduce the loss of the vibration and relieve the echo phenomenon caused by separation of the transmission path.

### BRIEF DESCRIPTION OF THE DRAWINGS

FIG. 1 is a perspective view illustrating an appearance of a mobile terminal in accordance with an exemplary embodiment;

FIGS. 2 to 9 are schematic cross-sectional views illustrating mobile terminals in accordance with exemplary embodiments;

FIGS. 10 to 13 are schematic cross-sectional views illustrating an acoustic element in accordance with another exemplary embodiment;

FIGS. 14 to 25 are schematic cross-sectional views illustrating acoustic elements in accordance with other exemplary embodiments; and

FIGS. 26 to 27 are schematic cross-sectional views illustrating mobile terminals in accordance with other exemplary embodiments.

### MODE FOR CARRYING OUT THE INVENTION

Hereinafter, exemplary embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

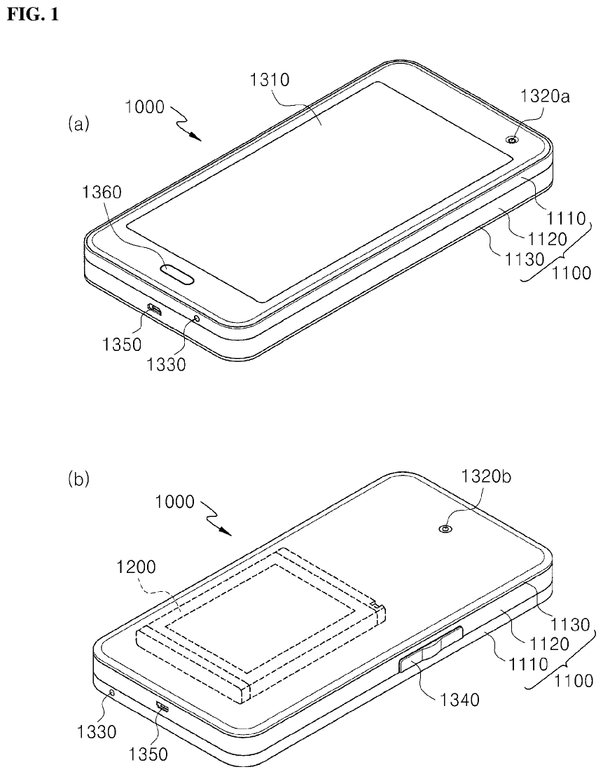

FIG. 1 is a perspective view illustrating an appearance of a mobile terminal in accordance with an exemplary embodiment, (a) of FIG. 1 is a front perspective view, and (b) of FIG. 1 is a rear perspective view.

Referring to FIG. 1, an electronic device 1000 includes a case 1100 configuring an appearance thereof. The case 1100 may include a front case 1110, a rear case, 1120, and a cover case 1130. The front case 1100 may have at least a portion having a plate shape to provide a display part 1310 on an upper side thereof. Also, a piezoelectric acoustic element in a bone conduction manner may be provided by contacting at least a portion of the front case 1110. The rear case 1120 is provided below the front case 1110, and at least a portion thereof has a plate shape. All sorts of components such as a circuit board may be embedded between the front case 1110 and the rear case 1120. That is, a predetermined space may be defined between the front case 1110 and the rear case 1120, and a circuit board and the like may be disposed in the space. Meanwhile, a battery 1200 may be disposed on the other surface of the rear case 1120, i.e., a predetermined area of the other surface opposite to one surface facing the front case 1110, and the cover case 1130 may be disposed on the rear surface of the rear case 1120 to cover the battery 1200. The battery 1200 may be embedded in the mobile terminal 1000 or directly attached to or detached from an outer surface of the mobile terminal 1000. Here, when the battery 1200 is detachable, the cover case 1130 may be also detachable, and when the battery 1200 is embedded to be fixed, the cover case 1130 may be also fixed. Meanwhile, the case 1100 may be injection-molded by using a synthetic resin or be made of metallic material such as stainless steel (STS), titanium (Ti), and aluminum (Al). Here, the front case 1100, the rear case 1120, and the cover case 1130 may be made of the same material, or at least one thereof may be made of a different material. For example, the front case 1100 and the rear case 1120 may be made of a metallic material, and the cover case 1130 may be made of a synthetic resin.

Meanwhile, a display part 1310, a camera module 1320a, and the like may be disposed on the front case 1110. Also, a microphone 1330, a side input part 1340, and an interface 1350 may be disposed on side surfaces of the front case 1110 and the rear case 1120. The display part 1310 occupies almost an entire surface of the front case 1110. That is, the display part 1310 is disposed on a front surface of a body of the electronic device to output visual information. A camera module 1320a is disposed above the display part 1310, and a front input part 1360 is disposed below the display part 1310. Also, the display part 1310 may provide a touch screen together with a touch sensor. Here, a piezoelectric vibration device may provide feedback in response to input or touch of a user, and the piezoelectric vibration device may contact the display part 1310. Alternatively, the piezoelectric vibration device may contact the front case 1110. Meanwhile, when the touch sensor is provided, the front input part 1360 may not be provided to the front surface of the terminal. The front input part 1360 may include a touch key and a push key or adopt a method in which the user operates by using a sense of touch. Also, the side input part 1340 may receive a command of adjusting sound volume or a command of converting into a touch recognition mode of the display part 1310.

A camera module 1320b may be additionally mounted on a rear surface of the mobile terminal 1000. That is, the camera module 1320b may be provided on a predetermined area of the rear case 1120 and exposed through the cover case 1130. The camera module 1320b may have a shooting direction substantially opposite to the camera module 1320a and a pixel different from that of the camera module 1320a. A flash (not shown) may be additionally disposed adjacent to the camera module 1320b.

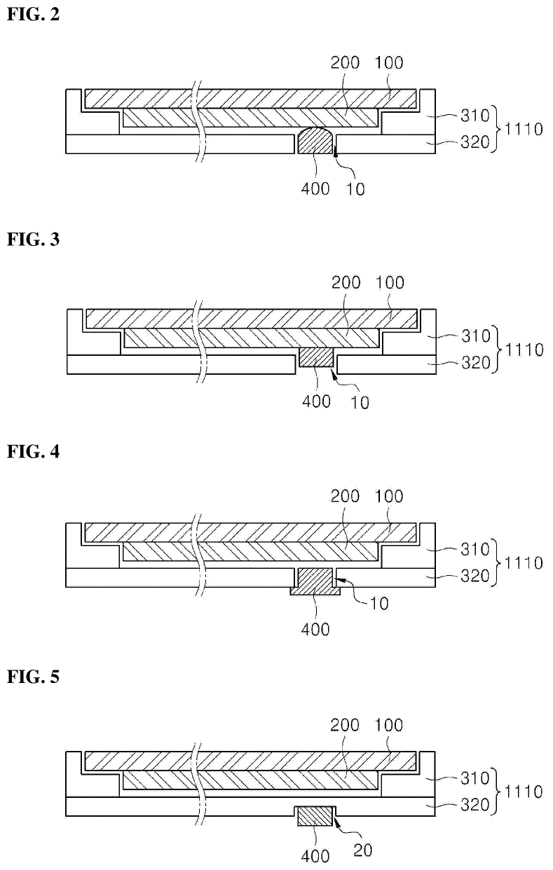

FIG. 2 is a schematic cross-sectional view of the mobile terminal in accordance with an exemplary embodiment, which includes at least a portion of the front case and the display part.

Referring to FIG. 2, the mobile terminal in accordance with an exemplary embodiment may include a window 100, a display 200 disposed on one side of the window 100, a front case 1110 (310 and 320) disposed on one side of the display 200, and an acoustic element 400 disposed on at least a portion of the front case 1110. Here, in the mobile terminal, the window 100, the display 200, and the front case 1110 may be disposed in a downward direction, the window 100 and the display 200 may closely contact each other, and a predetermined space may be defined between the display 200 and the front case 1110. That is, the display part 1310 including the window 100 and the display 200 may be disposed on the front case 1110, and the acoustic element 400 may be disposed to contact at least a portion of the front case 1110.

An object such as a finger and a stylus pen contacts the window 100. The above-described window 100 may be made of a light-transmittable material such as a light-transmitting synthetic resin and tempered glass. The window 100 may include a non-light-transmittable portion. That is, the window 100 may be divided into an edge area that is opaquely treated and a central area surrounded by the edge area. The edge area is seated on and supported by one area of the front case 1110, and the central area may have a surface area corresponding to the display 200. Through this, the user may recognize visual information outputted from the display 200 from the outside. Also, the window 100 may be firmly fixed to the front case 1110 by using an adhesion film (not shown). The adhesion film may seal a gap between the display 200 and the window 100 to prevent foreign substances from being introduced therebetween and have a loop shape corresponding to edges of the window 100 and the front case 1110. Meanwhile, since the mobile terminal in accordance with an exemplary embodiment transmits sound by using vibration generated from the acoustic element 400, a hole or a groove for emitting sound may not be defined in the window 100.

The display 200 is disposed on the rear surface of the window 100 and accommodated in the front case 1110. The display 200 is electrically connected to a circuit board (not shown) to output visual information through control of a control part. The display 200 may have a surface area corresponding to the light-transmittable portion of the window 100. The above-described display 200 may include one of, e.g., a liquid crystal display (LCD), a thin film transistor-liquid crystal display (TFT LDC), an organic light-emitting diode (OLED), a flexible display, and a 3D display. Also, the display 200 may additionally include a touch sensor (not shown) to configure a touch screen. The touch sensor is disposed between the window 100 and the display 200 to detect touch input on the window 100. The touch sensor converts variation of voltage and electrical charge generated on a specific portion of the window 100 into an electrical input signal. The touch sensor is light-transmittable to transmit an image provided from the display 200 therethrough. In the touch sensor, an area corresponding to the light-transmittable portion of the window 100 is an input area. The touch sensor may have a conductive pattern in which a conductive material is patterned on the window 100 itself or a separate film in a deposit and printing method. As a conductive material, an indium tin oxide (ITO), a carbon nano tube (CNT), a conductive polymer, In2O3, SnO2, Au, and the like may be used. The touch sensor may have a film type and be attached to the rear surface of the window 100. Here, an adhesion layer for coupling the window 100 to the touch sensor may be disposed therebetween. As the adhesion layer, optical clear adhesive (OCA) and a super view resin (SVR) may be used. Also, the display 200 may further include a pressure sensor. The pressure sensor including first and second electrodes, which are spaced a predetermined distance from each other, and a dielectric layer disposed therebetween and in which a distance between the first and second electrodes is varied based on a push pressure of the window 100 and, accordingly, a thickness of the dielectric layer is varied to vary capacitance thereof may be used. Accordingly, the dielectric layer may have various types including, e.g., a plurality of air gaps. Alternatively, a piezoelectric layer may be used as the pressure sensor instead of the dielectric layer. The above-described pressure sensor may be disposed between the window 100 and the display 200, between the display 200 and the front case 1110, or between the window 100 and the front case 1110. The display 200 may be modularized with the window 100 to provide one assembly. In particular, when at least one of the touch sensor and the pressure sensor is provided, the display 200 is operated as a touch input device.

The front case 1110 may support the edge of the window 100 and be disposed below the display 200 by being spaced therefrom. That is, the front case 1110 may include a support part 310 supporting the edge of the window 100 and a flat plate part 320 spaced apart from a bottom surface of the display 200 and of which a portion is connected to the support part 310. Here, the support part 310 may include a vertical portion vertically provided along the edge of the window 100 and a horizontal portion inward protruding from the vertical portion to support the edge of the window 100. Thus, the vertical portion may surround the window 100, and the horizontal portion may contact the edge of the window 100 to support the window 100. Meanwhile, the display 200 may be disposed inside the horizontal portion. Resultantly, the support part 310 may have an L-shape. Meanwhile, a partial area of the support part 310 disposed below the window 100 may have a thickness greater than that of the display 200. Accordingly, the flat plate portion 320 connected below the support part 310 may be disposed below the display 200 by being spaced a predetermined distance therefrom. Meanwhile, the rear case 1120 may be spaced apart from and disposed below the front case 1110 as described by using FIG. 1. A predetermined space is defined between the front case 1110 and the rear case 1120, and all sorts of electronic components are embedded in the space. At least one intermediate case (not shown) may be additionally disposed between the front case 1110 and the rear case 1120. Also, an opening 10 may be defined in a predetermined area of the front case 1110, i.e., a predetermined area of the support part 310 or the flat plate part 320. The opening 10 may be defined to expose a predetermined area of the display 200.

The acoustic element 400 is electrically connected to a circuit board (not shown) disposed in the mobile terminal to generate vibration according to the control of the control part. The acoustic element 400 generates sound through air-vibration due to oscillation or transmits sound in a bone conduction manner and an air conduction manner. The acoustic element 400 may include, e.g., a bone conduction speaker and a bone conduction receiver. The bone conduction speaker or the bone conduction receiver transmits sound in the bone conduction manner. The bone conduction uses a phenomenon in which a bone conduction transducer that is a converter converting an electrical signal into a vibration signal is provided and sound is conducted to a skull and directly transmitted to an internal ear without passing through an eardrum. The bone conduction is a concept corresponding to air conduction representing that sound in the air is heard by arriving to an internal ear through an external auditory meatus, an eardrum, and an auditory ossicle. A bone conduction transducer is attached to the bone conduction speaker or the bone conduction receiver, and the bone conduction transducer serves as a vibration speaker converting an electrical signal into a vibration signal to transmit sound. The acoustic element 400 may be realized by using the piezoelectric element. That is, the acoustic element 400 may include a piezoelectric vibration element, and the piezoelectric vibration element may further include the vibration element in addition to the piezoelectric element. For example, the acoustic element 400 may include the piezoelectric element and the piezoelectric vibration element including the vibration element attached to one surface of the piezoelectric element. The configuration of the acoustic element including the piezoelectric element and the vibration element will be described later in detail. The acoustic element 400 may include the piezoelectric element to have a plate shape or be modularized in a module case. Meanwhile, the acoustic element 400 may be inserted into the opening 10, and at least a portion thereof may contact the display 200. For example, the acoustic element 400 has one surface, which faces the display 200, protruding from an edge to a central portion thereof, and thus the central portion, i.e., the most protruding area, contacts the display 200. The acoustic element 400 is mounted on the front case 1110 to transmit generated vibration to the window 100.

That is, since the flat plate part 320 is connected to the support part 310, and the support part 310 is connected to the window 100 in the front case 1110 to which the acoustic element 400 is mounted, the vibration of the acoustic element 400 may be transmitted to the window 100 through the flat plate part 320 and the support part 310 of the front case 1110, and the user may hear sound through the vibration as a head of the user contacts the window 100 during calling. Meanwhile, the mobile terminal in accordance with an exemplarily embodiment may further include a circuit board (not shown) and the rear case 1120 illustrated in FIG. 1 in addition to the window 100, the display 200, the front case 1110, and the acoustic element 400. The rear case 1120 may be coupled to the front case 1110 to cover the acoustic element 400, and a discharging hole (not shown) discharging surrounding air of the acoustic element 400 may be defined in the rear case 1120. Through this, a resonance phenomenon generated from the rear surface of the acoustic element 400 may be relieved or removed. Also, the cover case 1130 may be provided to cover the rear case 1120. Accordingly, the acoustic element 400 may be provided to the rear case 1120 or the cover case 1130. That is, the acoustic element 400 may be provided to the rear case 1120 or the cover case 1130 as well as the front cover 1110.

Also, the acoustic element 400 may contact the front case 1110 and the display 200 through the front case 1110 in various manners. These various embodiments are illustrated in FIGS. 2 to 8.

As illustrated in FIG. 3, the acoustic element 400 having one flat surface is inserted into the opening 10 defined in the flat plate part 320 of the front case 1110 to contact the display 200.

Also, as illustrated in FIG. 4, the acoustic element 400 may be inserted into the opening 10 while a portion of an upper side thereof contacts the flat plate part 320 of the front case 1110. That is, the acoustic element 400 may include a portion inserted into the opening 10 and another portion that is greater in width and thus not inserted into the opening 10 and supported by the flat plate part 320 of an inlet of the opening 10. Accordingly, as at least a portion of the acoustic element 400 is supported by the flat plate part 320, at least a portion thereof may be inserted into the opening 10. Here, the support area may be less in thickness than the area inserted into the opening 10, and an adhesion member is provided to the support area to attach the acoustic element 400 to the flat plate part 320.

As illustrated in FIG. 5, a groove 20 may be defined in the flat plate part 320 of the front case 1110, and the acoustic element 400 may be inserted into the groove 20. Here, while the opening 10 passes through the support part 310 or the flat plate part 320 to expose the display 200 through the support part 310 or the flat plate part 320, the groove 20 may be defined by removing a portion of the support part 310 or the flat plate part 320 to allow a predetermined thickness to be remained.

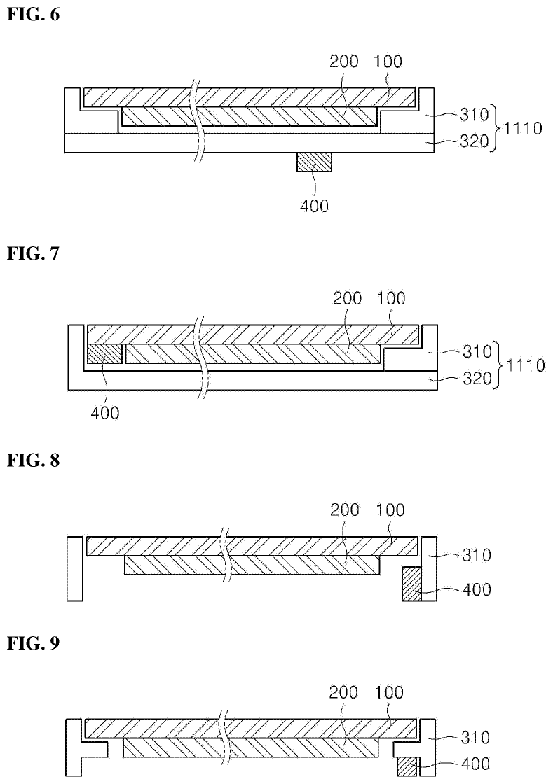

As illustrated in FIG. 6, the acoustic element 400 may be provided on one surface of the front case 1110 without defining the opening 10 or the groove 20 therein. That is, the acoustic element 400 may be disposed on a predetermined area of the other surface of the flat plate part 320, which does not face the display 200.

Alternatively, the acoustic element 400 may be directly attached to one area of the window 100. That is, as illustrated in FIG. 7, the acoustic element 400 may be disposed on an area on which the display 200 is not provided, i.e., an outer area of the display 200, and, in this case, the support part 310 of the front case 1110 may be varied in shape.

Meanwhile, the front case 1110 may be varied in shape, and the acoustic element 400 may be provided on a predetermined area of the front case 1110. For example, as illustrated in FIG. 8, the front case 1110 may be fixed by contacting an edge of the window 100 to surround the window 100, and the acoustic element 400 may be disposed on one area of the front case 1110. For example, the acoustic element 400 may contact an area of the front case 1110, which is disposed below the window 100 and on which the display 200 is not provided. Alternatively, as illustrated in FIG. 9, the front case 1110 may not include the flat plate part 320, and, in this case, the acoustic element 400 may be provided below the support part 310 supporting the window 100. That is, the horizontal portion of the support part 310 may have one surface contacting to support the window 100 and the other surface on which the acoustic element 400 is provided.

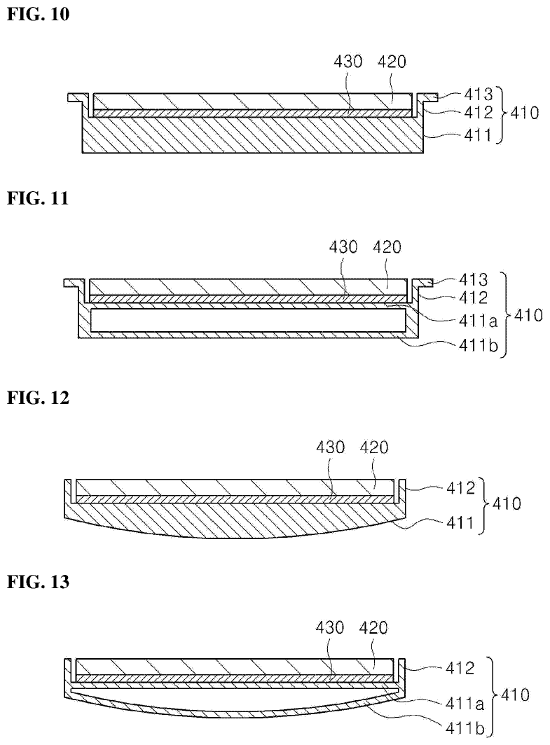

FIGS. 10 to 13 are cross-sectional views illustrating acoustic elements in accordance with exemplary embodiments.

Referring to FIG. 10, the acoustic element 400 in accordance with an exemplary embodiment may include a module case 410, a piezoelectric vibration member 420 provided in the module case 410, and an adhesion member 430 attaching at least a portion of the piezoelectric vibration member 420 to the module case 410. The module case 410 amplifies vibration of the piezoelectric vibration member 420 and transmits the vibration to the mobile terminal. That is, the module case 410 amplifies the vibration of the piezoelectric vibration member 420 to transmit the amplified vibration to the mobile terminal. The module case 410 may have an approximately hexahedral shape having an inner space. That is, the module case 410 may include a plane portion 411, a vertical portion 412 extending upward from an outer side, and a protruding portion 413 protruding from an upper side of the vertical portion 412 to the outside. The plane portion 411 may have a predetermined thickness. Here, a thickness of the plane portion 411 may be greater than that of the piezoelectric vibration member 420. For example, the thickness of the plane portion 411 may be greater two to four times than that of the piezoelectric vibration member 420. Also, a space for accommodating the piezoelectric vibration member 420 may be defined by the vertical portion 412. Thus, in consideration of the thicknesses of the piezoelectric vibration member 420 and the adhesion member 430, the vertical portion 412 may have the same height as those thereof. Also, as illustrated in FIG. 4, the protruding portion 413 allows the acoustic element 400 to be supported by the front case 1110 when the acoustic element 400 is inserted into the opening 10 of the front case 1110. Here, the protruding portion 413 and an outer surface of the front case 1110 may be attached and fixed to each other by applying adhesive on the front case 1110. Alternatively, the protruding portion 413 may be screw-coupled to the front case 1110 to fix the acoustic element 400 to the front case 1110. Meanwhile, the piezoelectric vibration member 420 may include a piezoelectric element and further include a vibration element. That is, the piezoelectric vibration member 420 may include the piezoelectric element and be vertically expanded and contracted according to applied voltage, and further include the vibration element to convert the expansion and contraction of the piezoelectric element into bending deformation, thereby generating vibration in the vertical direction.

As illustrated in FIG. 11, first and second plane portions 411a and 411b may be provided above and below the plane portion 411 to define an inner space therebetween. That is, the first and second plane portion 411a and 411b may be vertically spaced a predetermined distance from each other, and vertical portions may be provided on outer sides thereof to define a predetermined space therebetween. The space may be used as a resonance space for resonating the vibration generated from the piezoelectric vibration member 420. Meanwhile, a different kind of material may be filled in the space. For example, a material different from that of each of the piezoelectric vibration member 420 and the module case 410, e.g., silicone, may be provided in the space. As the different kind of material is filled in the space as described above, vibration characteristics may be adjusted.

As illustrated in FIG. 12, the plane portion 411 may have one rounded surface. That is, as illustrated in FIG. 2, one surface may be rounded, and the rounded surface may contact the display 200 through the front case 1110. That is, the plane portion 411 may line-contact the display 200 through the front case 1110 as illustrated in FIG. 2.

Alternatively, as illustrated in FIG. 13, the first and second plane portion 411a and 411b are vertically spaced apart from each other to define a predetermined space in the module case 410. Also, a different kind of material may be filled in the space between the first and second plane portions 411a and 411b.

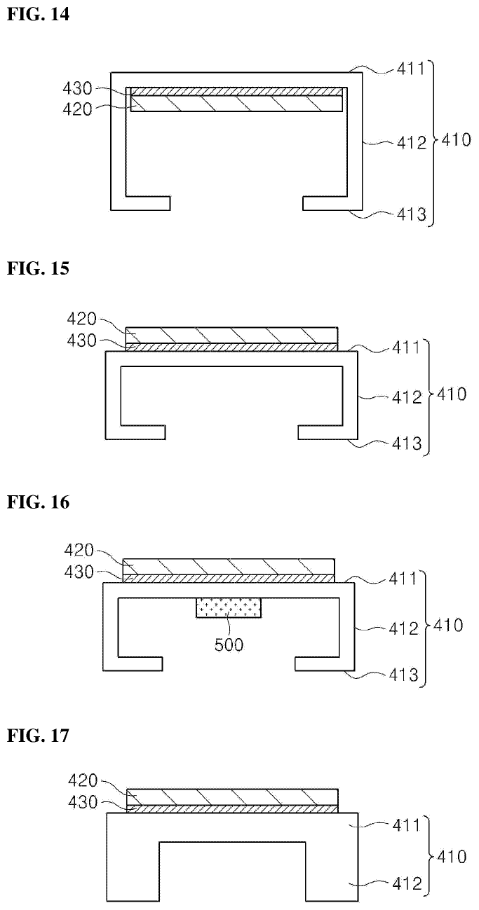

FIGS. 14 to 25 are cross-sectional views illustrating the acoustic element in accordance with other exemplary embodiments.

Referring to FIG. 14, the acoustic element may include a module case 410, a piezoelectric vibration member 420 provided in the module case 410, and an adhesion member 430 attaching the piezoelectric vibration member 420 to the module case 410. Here, the module case 410 may have an approximately [symbol] -shape having one opened side. That is, the module case 410 may include an approximately rectangular shaped plane portion 4111, a vertical portion 412 extending from each of edges of the plane portion 411 in one direction, and an extension portion 413 extending inward from each of edges of the vertical portion 412. Here, the extension portion 413 may face the plane portion 411 and have an opened central portion. That is, the module case 410 may have a structure having a predetermined inner space and one opened side. The piezoelectric vibration element 420 may be provided in the module case 410, and the piezoelectric vibration element 420 may be attached to the plane portion 411 by using the adhesion member 430. Also, after the piezoelectric vibration element 420 is attached to the module case 410, a predetermined space may be defined in the module case 410. That is, as the vertical portion 412 of the module case 410 is provided higher than thicknesses of the piezoelectric vibration element 420 and the adhesion member 430, the predetermined space may be defined in the module case 410. Here, the module case 410 may amplify vibration of the piezoelectric vibration member 420 and transmit the amplified vibration to the mobile terminal. That is, the plane portion 411 of the module case 410 may serve as a vibration plate.

Referring to FIG. 15, the piezoelectric vibration member 420 may be attached to one side of the module case 410 having an approximately [symbol] -shape having a predetermined inner space and one opened side by using the adhesion member 430. Here, the piezoelectric vibration member 420 may be attached to an outer surface of the module case 410, i.e., the plane portion 411 thereof. Here, a height from the module case 410 to the piezoelectric vibration member 420 may be the same as that of the module case 410 in FIG. 14. Surely, the module case 410 may have various heights according to a size and a height of a predetermined area of the mobile terminal to which the module case 410 is mounted.

Referring to FIG. 16, a weight member 500 amplifying the vibration of the piezoelectric vibration member 420 may be further provided inside the module case 410. The weight member 500 has an approximately hexahedral shape having a predetermined length, a predetermined width, and a predetermined thickness. Here, the weight member 500 may be fixed to the module case 410 by using an adhesion member (not shown). The weight member 500 vibrates by and together with the vibration of the piezoelectric vibration member 420 and adds own weight to the vibration. When the weight of the weight member 500 is added to the vibration when the weight member 500 is coupled to the module case 410, as a result, the weight of the vibration body increases to intensify vibration force while resonant frequency decreases in comparison with that when only the piezoelectric vibration member 420 vibrates. Alternatively, the weight member 500 may be disposed on the piezoelectric vibration member 420 to contact the piezoelectric vibration member 420. That is, the weight member 500 may contact the module case 410 or the piezoelectric vibration member 420.

Referring to FIG. 17, the piezoelectric vibration member 420 may be attached to one side of the module case 410 having a predetermined inner space and one opened side by using the adhesion member 430. Here, the module case 410 may have an approximately [symbol] -shape including the plane portion 411 having an approximately rectangular shape and the vertical portion 412 extending from an edge of the plane portion 411 in one direction. Also, the piezoelectric vibration member 420 may be disposed on one surface of the plane portion 411 in a direction opposite to a direction in which the vertical portion 412 is provided. Here, the module case 410 amplifies the vibration of the piezoelectric vibration member 420 and transmits the amplified vibration to the mobile terminal. Accordingly, the plane portion 411 of the module case 410 may serve as a vibration plate.

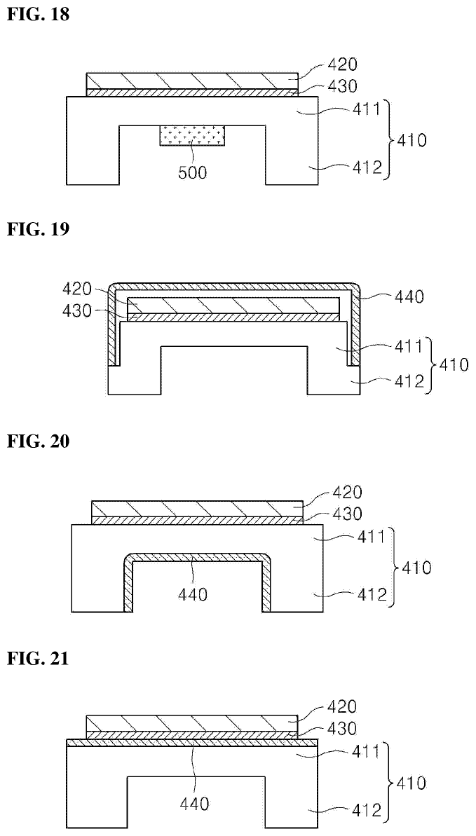

Referring to FIG. 18, the piezoelectric vibration member 420 may be disposed on one side of the module case 410 having a predetermined inner space and one opened side, and the weight member 500 may be disposed on the other side thereof. That is, the piezoelectric vibration member 420 may be provided on one surface of the plane portion 411 of the module case 410, and the weight member 500 may be provided on the other surface of the plane portion 411 thereof. Accordingly, the weight member 500 may be provided inside the module case 410, and the piezoelectric vibration member 420 may be provided outside the module case 410.

Referring to FIG. 19, the piezoelectric vibration member 420 may be attached to one side of the module case 410 having an approximately [symbol] -shape having one opened side by using the adhesion member 430. Here, the module case 410 may have an approximately [symbol] -shape including the plane portion 411 having an approximately rectangular shape and the vertical portion 412 extending from an edge of the plane portion 411 in one direction. Also, the piezoelectric vibration member 420 may be disposed on one surface of the plane portion 411 in a direction opposite to a direction in which the vertical portion 412 is provided. Also, a stiffener 440 may be further provided to cover the module case 410 and the piezoelectric vibration member 420. That is, after a predetermined width of a predetermined area of the vertical portion 412 of the module case 410 is removed, the stiffener 440 having the approximately [symbol] -shape may be provided to contact the area. The stiffener 440 may be provided to protect the piezoelectric vibration member 420 and reinforce the intensity of the module case 410. Here, the stiffener 440 may contact the vertical portion 412 of the module case 410 and be spaced apart from the piezoelectric vibration member 420. Accordingly, the piezoelectric vibration member 420 may be disposed inside the stiffener 440. Even in this case, the weight member may be further provided inside the module case 410 or on the piezoelectric vibration member 420.

Referring to FIG. 20, the stiffener 440 may be provided inside the module case 410. That is, the stiffener 440 may be provided on the plane portion 411 and the vertical portion 412 inside the module case 410.

Referring to FIG. 21, the stiffener 440 may be provided on one side of the plane portion 411 of the module case 410, and the piezoelectric vibration member 420 may be provided thereabove by using the adhesion member 430.

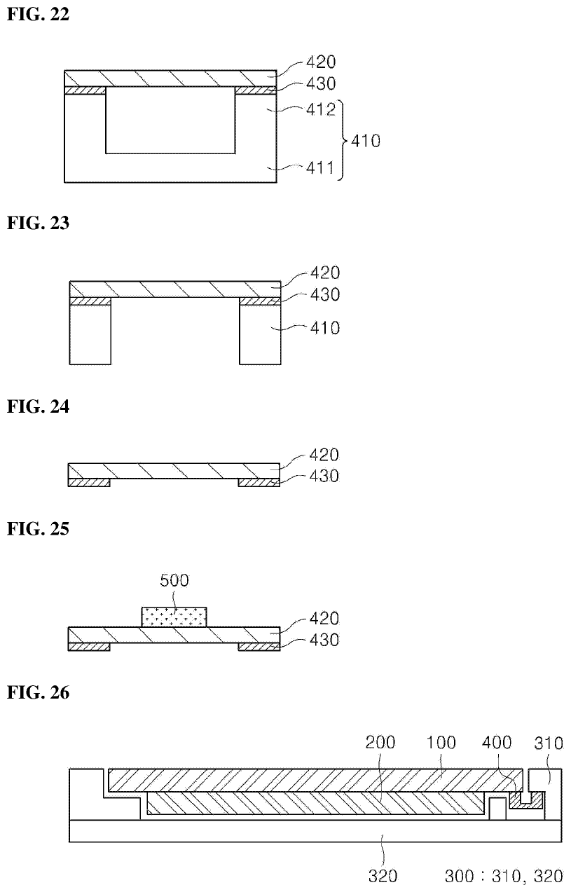

Referring to FIG. 22, the module case 410 may include the plane portion 411 and the vertical portion 412 extending a predetermined height from an edge of the plane portion 411, and the piezoelectric vibration member 420 may be provided on the vertical portion 412 by using the adhesion member 430. That is, although the piezoelectric vibration member 420 is provided on the plane portion 411 in the exemplary embodiments described in FIGS. 14 to 20, the piezoelectric vibration member 420 may be provided on the vertical portion 412 as described in FIG. 22. Accordingly, the piezoelectric vibration member 420 has an edge supported by the vertical portion 412 and the rest portion spaced a predetermined distance from the plane portion 411. Accordingly, a predetermined space may be defined between the piezoelectric vibration member 420 and the plane portion 411.

Referring to FIG. 23, the module case 410 may be provided along an edge of the piezoelectric vibration member 420. That is, the module case 410 may not include the plane portion and be provided along the shape of the piezoelectric vibration member 420. For example, when the piezoelectric vibration member 420 has a circular shape, the module case 410 may have a circular ring shape.

Meanwhile, the acoustic element 400 may include only the piezoelectric vibration member 420 without including the module case. That is, as illustrated in FIG. 24, the adhesion member 430 may be provided on one area of the piezoelectric vibration member 420, e.g., an edge thereof, and the piezoelectric vibration member 420 may be attached to a predetermined area of the mobile terminal by using the adhesion member 430. Also, in this case, the weight member 500 may be provided on one surface of the piezoelectric vibration member 420 as illustrated in FIG. 25.

Meanwhile, the acoustic element 400 in accordance with exemplary embodiments may include a piezoelectric element and a vibration element. That is, the piezoelectric vibration member 420 may include the piezoelectric element and further include the vibration element. The piezoelectric element may have, e.g., a rectangular plate shape having a predetermined thickness. Alternatively, the piezoelectric element may have various shapes such as a square shape, a rectangular shape, an oval shape, and a polygonal shape in addition to the circular shape. That is, the piezoelectric element may have various shapes according to the shapes of the acoustic element 400 and the module case 410. The piezoelectric element may include a board and a piezoelectric layer disposed on at least one surface of the board. For example, the piezoelectric element may be provided as a bimorph type piezoelectric element in which the piezoelectric layer is provided on both surfaces of the board or a unimorph type piezoelectric element in which the piezoelectric layer is provided on one surface of the board. At least one piezoelectric layer may be laminated to provide the piezoelectric layer, and, preferably, a plurality of piezoelectric layers may be laminated to provide the piezoelectric layer. Also, an electrode may be provided on each of upper and lower portions of the piezoelectric layer. That is, a plurality of piezoelectric layers and a plurality of electrodes may be alternately laminated to realize the piezoelectric element. Here, the piezoelectric layer may be provided by using, e.g., PZT (Pb, Zr, Ti), NKN (Na, K, Nb), or BNT (Bi, Na, Ti), and a polymer-based piezoelectric material. Alternatively, the piezoelectric layer may be polarized in different directions or the same direction and then be laminated with each other. That is, when the plurality of piezoelectric layers are provided on one surface of the board, the polarizations of each of the piezoelectric layers may be alternately provided in the different directions or the same direction. Meanwhile, the board may be made of a material having a property generating vibration while maintaining a structure in which the piezoelectric layers are laminated, e.g., metal or plastic. However, the piezoelectric element may not use the piezoelectric layer and the board. For example, the piezoelectric layer that is not polarized may be provided on a central portion of the piezoelectric element, and the plurality of piezoelectric layers polarized in directions different from each other may be laminated thereabove and therebelow to provide the piezoelectric element. Meanwhile, an electrode pattern (not shown) to which a driving signal is applied may be provided on an upper portion of one surface of the piezoelectric element. At least two electrode patterns may be provided to be spaced from each other and connected to a connecting terminal (not shown) to receive an acoustic signal from an electronic device such as an auxiliary mobile device through the connecting terminal.

Also, the vibration element attached to the piezoelectric element may be further provided. The vibration element may have the same shape as that of the piezoelectric element and be greater in size than that of the piezoelectric element. The piezoelectric element may be attached on a top surface of the vibration element by using adhesive. The vibration element may be made of a polymer-based material or a pulp-based material. For example, the vibration element may be made of a resin film. For example, a material having a large loss coefficient with a Young's ratio of about 1 MPa to about 10 MPa such as an ethylene propylene rubber-based material and a styrene butadiene rubber-based material.

Meanwhile, a coating layer (not shown) may be further provided on at least a portion of the piezoelectric vibration member 420. The coating layer may be made of a waterproofing material such as parylene. The pyrylene may be applied on top and side surfaces of the piezoelectric element and top and side surfaces of the vibration element exposed by the piezoelectric element in a state in which the piezoelectric element is attached on the vibration element. That is, the pyrylene may be provided on the top and side surfaces of the piezoelectric element and the vibration element. Alternatively, the pyrylene may be applied on top and side surfaces of the piezoelectric element and top, side, and bottom surfaces of the vibration element in the state in which the piezoelectric element is attached on the vibration element. That is, the pyrylene may be provided on the top, side, and bottom surfaces of the piezoelectric element and the vibration element. Also, when the piezoelectric element is provided on an opening defined in a central portion of the vibration element, the parylene may be provided on the top and side surfaces and the bottom surface exposed by the opening of the piezoelectric element and, at the same time, on the top, side, and bottom surfaces of the vibration element. As the parylene is provided on at least one surface of the piezoelectric element and the vibration element, moisture may be prevented from being introduced to prevent oxidation. In addition, eccentric vibration generated by using a vibration element made of a thin material such as a polymer may be improved, and a response speed may be improved due to increase in hardness of the vibration element to relieve deep acoustic characteristics and stabilize upper register. Also, the resonant frequency may be adjusted according to a coating thickness of the parylene. Also, the parylene may be applied on only the piezoelectric element or on the top, side, and bottom surfaces of the piezoelectric element. In addition, the parylene may be applied on FPCB coupled to the piezoelectric element to supply power to the piezoelectric element. As the parylene is provided on the piezoelectric element, moisture may be prevented from being introduced into the piezoelectric element, and oxidation thereof may be prevented. Also, as formation thickness is adjusted, the resonant frequency may be adjusted. Meanwhile, when the parylene is provided on the FPCB, noise generated from a joint between the FPCB, a solder, and an element may be improved. The above-described parylene may be applied with different thicknesses according to materials and features of the piezoelectric element or the vibration element. For example, the parylene may have a thickness less than that of the piezoelectric element or the vibration element, e.g., a thickness of about 0.1 μm to about 10 μm. For example, to apply the parylene, when the parylene is vaporized by being first-heated in a vaporizer and converted into a dimmer state, and then thermally decomposed into a monomer state by being second-heated and cooled, the parylene may be converted from the monomer state into the polymer state and applied at least one surface of the piezoelectric vibration member 420. Meanwhile, the waterproof layer such as the parylene may be applied on at least a portion of the piezoelectric vibration member 420 and at least a portion of the module case 410.

Meanwhile, the acoustic element 400 in accordance with an exemplary embodiment and other exemplary embodiments may be installed on the mobile terminal as illustrated in FIG. 26. That is, as illustrated in FIG. 26, the mobile terminal may include a window 100, a display 200 disposed on one side of the window 100, a front case disposed on one side of the display 200, and an acoustic element 400 disposed on at least a portion of a front case 1110. Also, the front case 1110 may include a support part 310 supporting an edge of the window 100 and a flat plate part 320 spaced apart from a bottom surface of the display 200 and of which a portion is connected to the support part 310. Here, the acoustic element 400 may be provided on at least a portion of the support part 310. That is, at least a portion of the support part 310, on which the acoustic element 400 is provided, may be removed, and the acoustic element 400 may be provided on the removed area. Here, the support part 310 on which the acoustic element 400 is not provided may include a vertical portion and a horizontal portion, and at least a portion of an inner side of the vertical portion and an upper side of the horizontal portion of the support part 310 on which acoustic element 400 is provided may be removed.

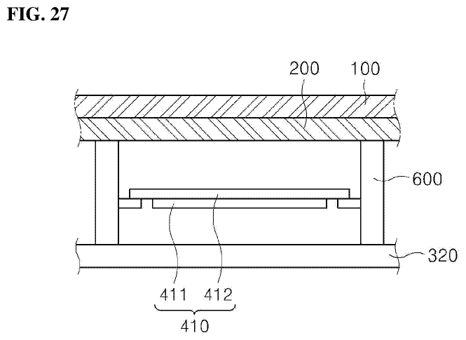

Also, as illustrated in FIG. 27, a support member 600 may be provided between a display 200 and a front case 1110, and an acoustic element 400 may be supported by a predetermined area of the support member 600. That is, the support member 600 may be provided on a predetermined area between the display 200 and a flat plate part 320 of the front case 1110, the support member 600 may include a protruding portion inward protruding in a horizontal direction, and the acoustic element 400 including a piezoelectric vibration member 410 may be provided to support by the protruding portion. Here, the piezoelectric vibration member 410 may include a piezoelectric element 411 and a vibration element 412, and an edge of the vibration element 412 may be supported on the protruding portion and the piezoelectric element 411 may be provided on at least one surface of the vibration element 412.

Although the mobile terminal has been described with reference to the specific embodiments, it is not limited thereto. Therefore, it will be readily understood by those skilled in the art that various modifications and changes can be made thereto without departing from the spirit and scope of the present invention defined by the appended claims.

1. A mobile terminal comprising:
a display configured to display an image;
a window disposed on one side of the display and touchable by a user;
a case disposed on the other side of the display from a side surface of the window; and
an acoustic element disposed on at least one area of the case,
wherein the acoustic element generates sound through air-vibration due to oscillation or transmits sound in a bone conduction manner.

2. The mobile terminal of claim 1, wherein the case comprises a front case, a rear case, and a cover case, and the acoustic element is disposed on at least one area of at least one of the front case, the rear case, and the cover case.

3. The mobile terminal of claim 2, further comprising an opening or a groove defined in at least one area of the front case, and at least a portion of the acoustic element is inserted into the opening or the groove.

4. The mobile terminal of claim 3, wherein the acoustic element contacts the display.

5. The mobile terminal of claim 1, wherein the acoustic element comprises a module case and a piezoelectric vibration member disposed on one area of the module case.

6. The mobile terminal of claim 5, wherein the module case has a rounded surface opposite to a surface contacting the piezoelectric vibration member.

7. The mobile terminal of claim 5, wherein the module case comprises a predetermined inner space.

8. The mobile terminal of claim 7, wherein a material different from that of the module case is filled in the inner space of the module case.

9. The mobile terminal of claim 5, wherein the module case has opened one side.

10. The mobile terminal of claim 7, wherein the piezoelectric vibration member is disposed in an inner space of the module case.

11. The mobile terminal of claim 5, further comprising a weight member disposed on at least one of the module case and the piezoelectric vibration member.

12. The mobile terminal of claim 5, further comprising a reinforcing material disposed on at least one area of the module case.

13. The mobile terminal of claim 12, wherein the reinforcing material is spaced a predetermined distance from the piezoelectric vibration member to cover the piezoelectric vibration member.

14. The mobile terminal of claim 1, further comprising a support member disposed between the display and the case, and the acoustic element is supported on the support member.

15. The mobile terminal of claim 1, wherein the acoustic element comprises a piezoelectric vibration member attached on the case.

16. The mobile terminal of claim 1, wherein a waterproofing layer is applied on at least one area of the acoustic element.
